(19) United States
(12) Patent Application Publication
(10) Pub. No.: US 2026/0290877 A1
(43) Pub. Date: Sep. 24, 2026

(54) ALL-SOLID-STATE RECHARGEABLE BATTERY, AND MANUFACTURING METHOD AND APPARATUS

(71) Applicant: SAMSUNG SDI CO., LTD., Yongin-si, Gyeonggi-do (KR)

(72) Inventors: Eun Jung KIM, Yongin-si, Gyeonggi-do (KR); Minjae KIM, Yongin-si, Gyeonggi-do (KR); Jeong Wan HAAM, Yongin-si, Gyeonggi-do (KR); Gijang AHN, Yongin-si, Gyeonggi-do (KR); Seungwon SHIN, Yongin-si, Gyeonggi-do (KR)

(21) Appl. No.: 18/880,407

(22) PCT Filed: Mar. 27, 2024
(86) PCT No.: PCT/KR2024/003878

§ 371 Date: Dec. 31, 2024

(30) Foreign Application Priority Data
Oct. 30, 2023 (KR) 10-2023-0146781

(51) Int. Cl. H01M 10/04; H01M 4/38; H01M 10/0562; H01M 10/0583; H01M 50/414; H01M 50/434; H01M 50/449

(52) U.S. Cl. CPC H01M 10/0468; H01M 4/382; H01M 10/0404; H01M 10/0562; H01M 10/0583; H01M 50/414; H01M 50/434; H01M 50/449; H01M 2300/008; H01M 2300/0094

(57) ABSTRACT

An all-solid-state rechargeable battery, and a method and apparatus for manufacturing the same are provided. An embodiment of the present disclosure provides an all solid-state rechargeable battery including a band-shaped negative electrode, a first solid electrolyte layer and a second solid electrolyte layer provided on opposite surfaces of the negative electrode, a first positive electrode stacked on the first solid electrolyte layer, and a second positive electrode stacked on the second solid electrolyte layer and spaced apart from the first positive electrode in a longitudinal direction of the negative electrode, wherein the negative electrode is folded and stacked in a zigzag pattern, and the first positive electrode and the second positive electrode are alternately arranged between folded and stacked portions.

### TECHNICAL FIELD

### (a) Field

The present disclosure relates to an all-solid-state rechargeable battery, and a method and apparatus for manufacturing the same.

### BACKGROUND ART

Recently, development of batteries with high energy density and safety is being actively pursued due to industrial demands. For example, lithium-ion batteries are being put to practical use not only in the information-related devices and communication devices fields, but also in the automobile field. In the automotive industry, safety is especially important because it is related to life.

Lithium-ion batteries currently on the market use electrolytes that contain flammable organic solvents, so there is a risk of overheating and fire if a short circuit occurs. For this reason, an all-solid-state rechargeable battery using a solid electrolyte instead of an electrolyte is being proposed.

All-solid-state rechargeable batteries do not use flammable organic solvents, which significantly reduces a risk of fire or explosion in the event of a short circuit. Accordingly, these all-solid-state batteries may significantly improve safety compared to lithium-ion batteries that use electrolytes.

The above-described information disclosed in the background technology of this disclosure is only for improving understanding of the background of the present invention, and therefore may include information that does not constitute prior art.

### DISCLOSURE

### Technical Problem

An embodiment attempts to provide an all-solid-state rechargeable battery capable of reducing assembly process costs and improving safety by simplifying an assembly process. An embodiment attempts to provide a manufacturing method for an all-solid-state rechargeable battery, capable of reducing assembly process costs and improving safety by simplifying an assembly process. An embodiment attempts to provide a manufacturing apparatus for an all-solid-state rechargeable battery, capable of reducing assembly process costs and improving safety by simplifying an assembly process.

### Technical Solution

An embodiment of the present disclosure provides an all solid-state rechargeable battery including a band-shaped negative electrode, a first solid electrolyte layer and a second solid electrolyte layer provided on opposite surfaces of the negative electrode, a first positive electrode stacked on the first solid electrolyte layer, and a second positive electrode stacked on the second solid electrolyte layer and spaced apart from the first positive electrode in a longitudinal direction of the negative electrode, wherein the negative electrode is folded and stacked in a zigzag pattern, and the first positive electrode and the second positive electrode are alternately arranged between folded and stacked portions.

Each of the first positive electrode and the second positive electrode may include a positive electrode substrate, and a first positive electrode active material layer and a second positive electrode active material layer formed on opposite surfaces of the positive electrode substrate.

The negative electrode may include a functional layer formed on opposite surfaces of the negative electrode substrate, and the first solid electrolyte layer and the second solid electrolyte layer may be respectively formed on functional layers on opposite surfaces.

Each of the first solid electrolyte layer and the second solid electrolyte layer may alternately correspond to a side end portion of the first positive electrode and a side end portion of the second positive electrode.

The functional layers may be formed as a coating layer of a polymer or a ceramic material on the negative electrode substrate.

The functional layers may be formed by bonding a separation layer to the negative electrode substrate.

The negative electrode may be formed from lithium metal, and the first solid electrolyte layer and the second solid electrolyte layer may be respectively formed on lithium metal on opposite surfaces.

The negative electrode may include a metal pattern formed on opposite surfaces of the negative electrode substrate, and the first solid electrolyte layer and the second solid electrolyte layer may be formed on metal patterns on opposite surfaces.

An embodiment of the present disclosure provides a manufacturing apparatus for an all solid-state rechargeable battery including a stack forming portion configured to include a band-shaped negative electrode, a first solid electrolyte layer and a second solid electrolyte layer provided on opposite surfaces of the negative electrode, a first positive electrode stacked on the first solid electrolyte layer, and a second positive electrode stacked on the second solid electrolyte layer and spaced apart from the first positive electrode in a longitudinal direction of the negative electrode, wherein the negative electrode is folded and stacked in a zigzag manner, and the first positive electrode and the second positive electrode are alternately arranged between folded and stacked portions to form a stack, a pair of stack guides formed to support lower and side surfaces of the stack and arranged oppositely at opposite sides in a zigzag width direction, an actuator connected to the stack guide to control movement of the stack guide in the width direction, and a high temperature press configured to press the stack supported on the stack guide.

The stack guide may include a lower plate corresponding to the lower surface of the stack, a front plate and a rear plate extending upward from the lower plate to support front and rear surfaces of the stack at an adjacent side to the stack, and a side plate extending upward from the lower plate to support a side surface of the stack from the lower plate.

The stack forming portion may stack the first positive electrode on the first solid electrolyte layer provided on a first surface of the negative electrode on which the band-shaped negative electrode advances, and may stack the second positive electrode on the second solid electrolyte layer spaced apart from the first positive electrode in the longitudinal direction of the negative electrode, and pressurize it with an upper roll and a lower roll.

The stack forming portion may include an upper roll configured to provide the first positive electrode by attaching it thereto, and a lower roll configured to provide the second positive electrode spaced apart from the first positive electrode in the longitudinal direction of the negative electrode by attaching it thereto, and may stack the first positive electrode on the first solid electrolyte layer provided on a first surface of the negative electrode on which the band-shaped negative electrode advances, and stacks the second positive electrode on the second solid electrolyte layer spaced apart from the first positive electrode in the longitudinal direction of the negative electrode, and pressurize it with the upper roll and the lower roll.

The stack forming portion may provide the first positive electrode by attaching it to a first plate such that the first positive electrode is stacked on the first solid electrolyte layer provided on a first surface of the negative electrode on which the band-shaped negative electrode advances, and pressurize and attach the first positive electrode to the first surface of the negative electrode by pressure with a first roll, and may provide the second positive electrode by attaching it to a second plate such that the second positive electrode is stacked on the second solid electrolyte layer, spaced apart from the first positive electrode in the longitudinal direction of the negative electrode, and pressurize and attach the second positive electrode to a second surface of the negative electrode 10 by pressure with a second roll.

The stack forming portion may provide the first positive electrode by attaching it to a first plate such that the first positive electrode is stacked on the first solid electrolyte layer provided on a first surface of the negative electrode on which the band-shaped negative electrode advances, and pressurize and attach the first positive electrode to the first surface of the negative electrode by pressure of a first press, and may provide the second positive electrode by attaching it to a second plate such that the second positive electrode is stacked on the second solid electrolyte layer, spaced apart from the first positive electrode in the longitudinal direction of the negative electrode, and pressurize and attach the second positive electrode to a second surface of the negative electrode 10 by pressure of a second press.

The stack forming portion may provide the first positive electrode between a left roll and the first solid electrolyte layer such that the first positive electrode is stacked on the first solid electrolyte layer provided on a first surface of the negative electrode on which the band-shaped negative electrode advances upward, and may provide the second positive electrode between a right roll and the second solid electrolyte layer such that the second positive electrode is stacked on the second solid electrolyte layer spaced apart from the first positive electrode in the longitudinal direction of the negative electrode, to apply pressure with the left roll and the right roll.

The stack forming portion may provide the first positive electrode between a left roll and the first solid electrolyte layer such that the first positive electrode is stacked on the first solid electrolyte layer provided on a first surface of the negative electrode on which the band-shaped negative electrode advances downward, and may provide the second positive electrode between a right roll and the second solid electrolyte layer such that the second positive electrode is stacked on the second solid electrolyte layer spaced apart from the first positive electrode in the longitudinal direction of the negative electrode, to apply pressure with the left roll and the right roll.

An embodiment of the present disclosure provides a manufacturing method for an all solid-state rechargeable battery including a first operation of including a band-shaped negative electrode, a first solid electrolyte layer and a second solid electrolyte layer provided on opposite surfaces of the negative electrode, a first positive electrode stacked on the first solid electrolyte layer, and a second positive electrode stacked on the second solid electrolyte layer and spaced apart from the first positive electrode in a longitudinal direction of the negative electrode, folding and stacking the negative electrode in a zigzag manner, and alternately arranging the first positive electrode and the second positive electrode between folded and stacked portions to form a stack, a second operation of supporting a lower surface and a side surface of the stack with a pair of stack guide that are arranged oppositely at opposite sides in a zigzag width direction to be advanced by an actuator, a third operation of pressing the stack supported on the stack guides with a high temperature press, and a fourth operation of removing the stack from the stack guides by retracting the stack guides supporting the lower and side surfaces of the completely pressed stack by the actuator.

The first operation may include an 11^{th} operation of stacking the first positive electrode 31 on the first solid electrolyte layer 21 provided on a first surface of the negative electrode on which the band-shaped negative electrode advances, a 12^{th} operation of stacking the second positive electrode on the second solid electrolyte layer spaced apart from the first positive electrode in the longitudinal direction of the negative electrode, and a 13^{th} operation of pressurizing the first positive electrode, the negative electrode, and the second positive electrode using an upper roll and a lower roll.

The first operation may include an 11^{th} operation of providing the first positive electrode by attaching it to an upper roll such that the first positive electrode is stacked on the first solid electrolyte layer provided on a first surface of the negative electrode on which the band-shaped negative electrode advances, a 12^{th} operation of providing the second positive electrode by attaching it to a lower roll such that the second positive electrode is stacked on the second solid electrolyte layer spaced apart from the first positive electrode in the longitudinal direction of the negative electrode, and a 13^{th} operation of pressurizing the first positive electrode, the negative electrode, and the second positive electrode using the upper roll and the lower roll.

The first operation may include an 11^{th} operation of providing the first positive electrode by attaching it to a first plate such that the first positive electrode is stacked on the first solid electrolyte layer provided on a first surface of the negative electrode on which the band-shaped negative electrode advances, a 12^{th} operation of pressurizing and attaching the first positive electrode to the first surface of the negative electrode by pressure between the first plate and a first roll, a 13^{th} operation of providing the second positive electrode by attaching it to a second plate such that the second positive electrode is stacked on the second solid electrolyte layer spaced apart from the first positive electrode in the longitudinal direction of the negative electrode, and a 14^{th} operation of pressurizing and attaching the second positive electrode to a second surface of the negative electrode 10 by pressure between the second plate and a second roll.

The first operation may include an 11^{th} operation of providing the first positive electrode by attaching it to a first plate such that the first positive electrode is stacked on the first solid electrolyte layer provided on a first surface of the negative electrode on which the band-shaped negative electrode advances, a 12^{th} operation of pressurizing and attaching the first positive electrode to the first surface of the negative electrode by pressure between the first plate and a first press, a 13^{th} operation of providing the second positive electrode by attaching it to a second plate such that the second positive electrode is stacked on the second solid electrolyte layer spaced apart from the first positive electrode in the longitudinal direction of the negative electrode, and a 14^{th} operation of pressurizing and attaching the second positive electrode to a second surface of the negative electrode 10 by pressure between the second plate and a second press.

The first operation may include an 11^{th} operation of providing the first positive electrode between a left roll and the first solid electrolyte layer such that the first positive electrode is stacked on the first solid electrolyte layer provided on a first surface of the negative electrode on which the band-shaped negative electrode advances upward, a 12^{th} operation of providing the second positive electrode between a right roll and the second solid electrolyte layer such that the second positive electrode is stacked on the second solid electrolyte layer spaced apart from the first positive electrode in the longitudinal direction of the negative electrode, and a 13^{th} operation of pressurizing the first positive electrode, the negative electrode, and the second positive electrode using the left roll and the right roll.

The first operation may include an 11^{th} operation of providing the first positive electrode between a left roll and the first solid electrolyte layer such that the first positive electrode is stacked on the first solid electrolyte layer provided on a first surface of the negative electrode on which the band-shaped negative electrode advances downward, a 12^{th} operation of providing the second positive electrode between a right roll and the second solid electrolyte layer such that the second positive electrode is stacked on the second solid electrolyte layer spaced apart from the first positive electrode in the longitudinal direction of the negative electrode, and a 13^{th} operation of pressurizing the first positive electrode, the negative electrode, and the second positive electrode using the left roll and the right roll.

### Advantageous Effects

In an embodiment, first and second solid electrolyte layers may be provided on opposite surfaces of a negative electrode, respectively, and first and second positive electrodes may be stacked on the first and second solid electrolyte layers, respectively, so the negative electrodes may be folded and stacked in a zigzag pattern so that the first and second positive electrodes are alternately arranged between the folded and stacked portions, thereby simplifying the assembly process of an all-solid-state rechargeable battery. Accordingly, an embodiment may reduce the cost according to the assembly process of an all-solid-state rechargeable battery and improve safety of the all-solid-state rechargeable battery.

### DESCRIPTION OF THE DRAWINGS

FIG. 1 illustrates a longitudinal cross-sectional view of an all-solid-state rechargeable battery according to an embodiment.

FIG. 2 illustrates a longitudinal cross-sectional view showing formation of a lithium metal layer of an all-solid-state rechargeable battery according to an embodiment.

FIG. 3 illustrates a cross-sectional view of an all-solid-state rechargeable battery according to a first embodiment of the present disclosure.

FIG. 4 illustrates a cross-sectional view of a state before zigzag stacking a negative electrode, a first solid electrolyte layer, a second solid electrolyte layer, a first positive electrode, and a second positive electrode to manufacture the all-solid-state rechargeable battery of FIG. 3.

FIG. 5 illustrates a cross-sectional view of a unit cell formed of a negative electrode, a solid electrolyte layer, and a positive electrode in FIG. 4.

FIG. 6 illustrates a cross-sectional view of a unit cell formed of a negative electrode, a solid electrolyte layer, and a positive electrode in an all-solid-state rechargeable battery according to a second embodiment of the present disclosure.

FIG. 7 illustrates a cross-sectional view of a unit cell formed of a negative electrode, a solid electrolyte layer, and a positive electrode in an all-solid-state rechargeable battery according to a third embodiment of the present disclosure.

FIG. 8 illustrates a cross-sectional view showing an operation of forming a stack in a manufacturing method for an all-solid-state rechargeable battery using a manufacturing apparatus for an all-solid-state rechargeable battery according to an embodiment of the present disclosure.

FIG. 9 illustrates a perspective view of a stack guide applied to the manufacturing apparatus of FIG. 8.

FIG. 10 illustrates a cross-sectional view of a manufactured all-solid-state rechargeable battery being removed in a manufacturing method using the manufacturing apparatus of FIG. 8.

FIG. 11 illustrates a perspective view showing a first embodiment forming a stack in a manufacturing method for an all-solid-state rechargeable battery using a manufacturing apparatus for an all-solid-state rechargeable battery according to an embodiment of the present disclosure.

FIG. 12 illustrates a perspective view showing a second embodiment forming a stack in a manufacturing method for an all-solid-state rechargeable battery using a manufacturing apparatus for an all-solid-state rechargeable battery according to an embodiment of the present disclosure.

FIG. 13 illustrates a side view showing a third embodiment forming a stack in a manufacturing method for an all-solid-state rechargeable battery using a manufacturing apparatus for an all-solid-state rechargeable battery according to an embodiment of the present disclosure.

FIG. 14 illustrates a side view showing a fourth embodiment forming a stack in a manufacturing method for an all-solid-state rechargeable battery using a manufacturing apparatus for an all-solid-state rechargeable battery according to an embodiment of the present disclosure.

FIG. 15 illustrates a side view showing a fifth embodiment forming a stack in a manufacturing method for an all-solid-state rechargeable battery using a manufacturing apparatus for an all-solid-state rechargeable battery according to an embodiment of the present disclosure.

FIG. 16 illustrates a side view showing a sixth embodiment forming a stack in a manufacturing method for an all-solid-state rechargeable battery using a manufacturing apparatus for an all-solid-state rechargeable battery according to an embodiment of the present disclosure.

FIG. 17 illustrates a flowchart of a manufacturing method for an all-solid-state rechargeable battery according to an embodiment of the present disclosure.

### MODE FOR INVENTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly described to the contrary, the word “comprise” and variations such as “comprises” or “comprising” will be understood to imply the inclusion of stated elements but not the exclusion of any other elements.

In the drawings, the thickness is enlarged to clearly express various layers and areas, and like reference numerals designate like elements throughout the specification. It will be understood that when an element such as a layer, film, area, or substrate is referred to as being “on” another element, it can be directly on the other element or intervening elements may also be present. In contrast, when an element is referred to as being “directly on” another element, there are no intervening elements present.

In addition, herein, “layer” includes not only a shape formed on an entire surface when observed in a plan view, but also a shape formed on some surfaces. Herein, “or” is not interpreted in an exclusive sense, and for example, “A or B” is interpreted as including A, B, A+B, etc.

Positive Electrode for all-Solid-State Rechargeable Battery

In an embodiment, in a positive electrode for an all-solid-state rechargeable battery including a current collector and a positive electrode active material layer disposed on the current collector, the positive electrode active material layer provides a positive electrode for an all-solid-state rechargeable battery including at least one of a positive electrode active material, a sulfide-based solid electrolyte, a binder, or a conductive material. However, the present disclosure is not limited thereto, and the positive electrode for an all-solid-state rechargeable battery may include more or fewer components than the components described above.

In an embodiment, the positive electrode for an all-solid-state rechargeable battery is manufactured by applying a positive electrode composition containing at least one of a positive electrode active material, a sulfide-based solid electrolyte, a binder, or a conductive material to a current collector, followed by drying and rolling.

### Positive Electrode Active Material

The positive electrode active material may be applied without limitation as long as it is commonly used in all-solid-state rechargeable batteries. For example, the positive electrode active material may be a compound capable of reversible intercalation and deintercalation of lithium, and may include a compound represented by any of the following chemical formulas.

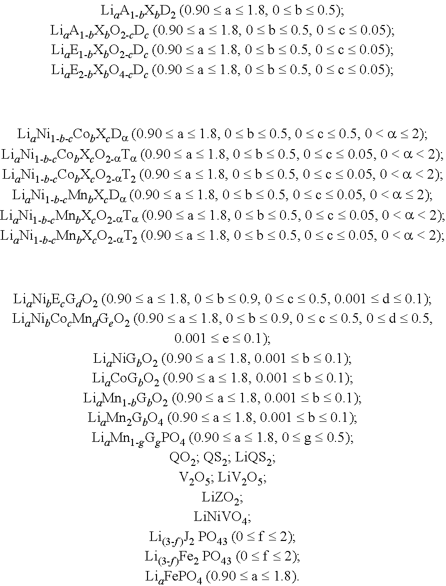

In the above formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, e.g., lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium Iron phosphate (LFP).

The positive electrode active material may include lithium nickel-based oxide represented by Formula 1 below, lithium cobalt-based oxide represented by Formula 2 below, lithium iron phosphate-based compound represented by Formula 3 below, or a combination thereof.

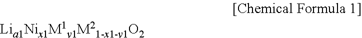

In Formula 1, 0.9≤a1≤1.8, 0.3≤x1≤1, and 0≤y1≤0.7, and M¹ and M² may each independently include one or more elements selected from Al, B, Ba, Ca, Ce, Co, Cr, Cu, F, Fe, Mg, Mn, Mo, Nb, P, S, Si, Sr, Ti, V, W, and Zr.

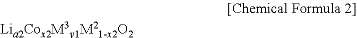

In Formula 2, 0.9≤a2≤:1.8 and 0.6≤x2≤1, and M³ may include one or more elements selected from Al, B, Ba, Ca, Ce, Co, Cr, Cu, F, Fe, Mg, Mn, Mo, Nb, P, S, Si, Sr, Ti, V, W, and Zr.

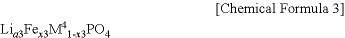

In Formula 3, 0.95≤a3≤1.8 and 0.6≤x3≤1, and M⁴ may include one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, e.g., 3 μm to 25 μm, 5 μm to 25 μm, 5 μm to 20 μm, 8 μm to 20 μm, or may be 10 μm to 18 μm. A positive electrode active material having this particle size range may be harmoniously mixed with other components within the positive electrode active material layer, and may achieve high capacity and high energy density.

The positive electrode active material may be in the form of secondary particles made by coagulating a plurality of primary particles, or may be in the form of single particles. Additionally, the positive electrode active material may be spherical or close to a spherical shape, or may be polyhedral or amorphous.

### Sulfide-Based Solid Electrolyte

Sulfide-based solid electrolytes may include, e.g., Li₂S—P₂S₅, Li₂S—P₂S₅—LiX (X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each integer and Z is Ge, Zn or Ga), Li₂S—GeS₂, Li₂S—SiS₂—Li₃PO₄, Li₂S—SiS₂—LiₚMO_{q} (p and q are integers, M is P, Si, Ge, B, Al, Ga or In), or a combination thereof.

Such sulfide-based solid electrolyte may be obtained by mixing, e.g., Li₂S and P₂S₅ at a molar ratio of 50:50 to 90:10, or 50:50 to 80:20 and optionally heat treating it. Within the above mixing ratio range, a sulfide-based solid electrolyte having excellent ionic conductivity may be manufactured. Herein, as another component, SiS₂, GeS₂, B₂S₃, etc. may be included more to further improve ionic conductivity.

Mechanical milling or solution method may be applied as a method of mixing sulfur-containing raw materials to produce a sulfide-based solid electrolyte. The mechanical milling is a method of mixing starting materials into fine particles by placing the starting materials and a ball mill in a reactor and stirring strongly. When using the solution method, solid electrolyte may be obtained as a precipitate by mixing the starting materials in a solvent. Additionally, if heat treatment is performed after mixing, the crystals of the solid electrolyte may become more solid and ionic conductivity may be improved. For example, a sulfide-based solid electrolyte may be manufactured by mixing sulfur-containing raw materials and heat treating it more than twice, and in this case, a sulfide-based solid electrolyte with high ionic conductivity and robustness may be manufactured.

For example, particles of the sulfide-based solid electrolyte may include argyrodite-type sulfide. The argyrodite-type sulfide may be represented by, e.g., a chemical formula of LiₐM_{b}P_{c}S_{d}Aₑ (a, b, c, d and e are all between 0 and 12, M is a metal other than Li or a combination of a plurality of metals other than Li, A is F, Cl, Br, or I), e.g., Li₇₋ₓPS₆₋ₓAₓ (x is 0.2 or more and 1.8 or less, and A is F, Cl, Br, or I). Specifically, the azirodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

Particles of the sulfide-based solid electrolyte containing such azirodite-type sulfide may have a high ionic conductivity close to the range of 10⁻⁴ to 10⁻² S/cm, which is the ionic conductivity of a general liquid electrolyte at room temperature, may form a tight bond between the positive electrode active material and the solid electrolyte without causing a decrease in ionic conductivity, and may further form a tight interface between the electrode layer and the solid electrolyte layer. All-solid-state batteries containing this may have improved battery performance such as rate characteristics, coulombic efficiency, and lifespan characteristics.

The ajirodite-type sulfide-based solid electrolyte may be prepared, e.g., by mixing lithium sulfide, phosphorus sulfide, and optionally lithium halide. After mixing them, heat treatment may be performed. The heat treatment may include, e.g., two or more heat treatment steps.

An average particle diameter (D50) of the particles of the sulfide-based solid electrolyte according to an embodiment may be 5.0 μm or less, e.g., 0.1 μm to 5.0 μm, 0.1 μm to 4.0 μm, 0.1 μm to 3.0 μm, 0.5 μm to 2.0 μm, or may be 0.1 μm to 1.5 μm. Alternatively, the particles of the sulfide-based solid electrolyte may be small particles with an average particle diameter (D50) of 0.1 μm to 1.0 μm, or large particles with an average particle diameter (D50) of 1.5 μm to 5.0 μm, depending on a position or purpose of use. Particles of the sulfide-based solid electrolyte in this particle size range may effectively penetrate between solid particles within a battery, and may have excellent contact with electrode active materials and connectivity between solid electrolyte particles. The average particle diameter of the particles of the sulfide-based solid electrolyte may be speed of using a microscope image, and for example, it may be obtained by measuring a size of about 20 particles in a scanning electron microscope image, obtaining a particle size distribution, and calculating D50 therefrom.

A content of the solid electrolyte in a positive electrode for an all-solid-state battery may be 0.5 wt % to 35 wt %, for example, 1 wt % to 35 wt %, 5 wt % to 30 wt %, 8 wt % to 25 wt. %, or 10 wt % to 20 wt %. This is a content relative to a total weight of the components in the positive electrode, and specifically, it may be said to be a content relative to a total weight of the positive electrode active material layer.

In an embodiment, the positive electrode active material layer may include 50 wt % to 99.35 wt % of the positive electrode active material with respect to 100 wt % of the positive electrode active material layer, 0.5 wt % to 35 wt % of the sulfide-based solid electrolyte, 0.1 wt % to 10 wt % of a fluorine-based resin binder, and 0.05 wt % to 5 wt % of vanadium oxide. If this content range is satisfied, the positive electrode for an all-solid-state rechargeable battery may achieve high capacity and high ionic conductivity while maintaining high adhesion, and viscosity of the positive electrode composition may be maintained at an appropriate level, thereby improving processability.

### Binder

The binder helps the particles of the positive electrode active material adhere to each other and also serves to adhere the positive electrode active material to the current collector, representative examples of which include polymers including polyvinyl alcohol, carboxymethylcellulose, hydroxypropylcellulose, diacetylcellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, etc., but the present disclosure is not limited thereto.

### Conductive Material

The positive electrode active material layer may further include a conductive material. The conductive material may be used to provide conductivity to the electrode, and may include, e.g., a carbon-based material such as natural graphite, artificial graphite, carbon black, acetylene black, Ketjen black, carbon fiber, and carbon nanotubes; a metallic substance containing copper, nickel, aluminum, silver, etc. and in the form of metal powder or metal fiber; a conductive polymer such as polyphenylene derivative; or a combination thereof.

The conductive material may be included in an amount of 0.1 wt % to 5 wt %, or 0.1 wt % to 3 wt %, based on a total weight of each component of the positive electrode for an all-solid-state battery, or based on a total weight of the positive electrode active material layer. Within the above content range, the conductive material may improve electrical conductivity without deteriorating battery performance.

If the positive electrode active material layer further includes a conductive material, the positive electrode active material layer may include 45 wt % to 99.25 wt % of the positive electrode active material with respect to 100 wt % of the positive electrode active material layer, 0.5 wt % to 35 wt % of the sulfide-based solid electrolyte, 0.1 wt % to 10 wt % of a fluorine-based resin binder, 0.05 wt % to 5 wt % of vanadium oxide, and 0.1 wt % to 5 wt % of a conductive material.

Meanwhile, the positive electrode for a lithium rechargeable battery may further include an oxide-based inorganic solid electrolyte in addition to the solid electrolyte described above. The oxide-based inorganic solid electrolyte may include, e.g., Li₁₊ₓTi₂₋ₓAl(PO₄)₃(LTAP)(0≤x≤4), Li_{1+x+y}AlₓTi₂₋ₓSi_{y}P_{3-y}O₁₂(0<x<2, 0≤y<3), BaTiO₃, Pb(Zr,Ti)O₃(PZT), Pb₁₋ₓLaₓZr_{1-y}Ti_{y}O₃(PLZT)(0≤x<1, 0≤y<1), PB(Mg₃Nb_{2/3})O₃—PbTiO₃(PMN-PT), HfO₂, SrTiO₃, SnO₂, CeO₂, Na2O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr; x is an integer from 1 to 10), or a combination thereof.

### All-Solid-State Rechargeable Battery

In an embodiment, an all-solid-state rechargeable battery is provided including the positive electrode and the negative electrode described above, and a solid electrolyte layer positioned between the positive electrode and the negative electrode. The all-solid-state rechargeable battery may be expressed as an all-solid-state battery or an all-solid-state lithium rechargeable battery.

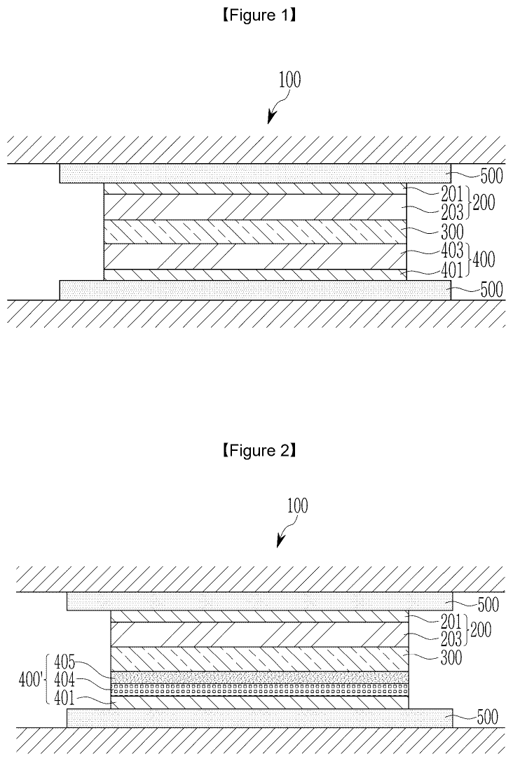

FIG. 1 illustrates a cross-sectional view of an all-solid-state rechargeable battery according to an embodiment. Referring to FIG. 1, the all-solid-state rechargeable battery 100 may include a structure in which a negative electrode 400 including a negative current collector 401 and a negative electrode active material layer 403, a solid electrolyte layer 300, and a positive electrode 200 including a positive electrode active material layer 203 and a positive current collector 201 are stacked is stored in a case such as a pouch. The all-solid-state rechargeable battery 100 may further include an elastic layer 500 outside at least one of the positive electrode 200 or the negative electrode 400. Although FIG. 1 shows one electrode assembly including the negative electrode 400, the solid electrolyte layer 300, and the positive electrode 200, an all-solid-state battery may also be manufactured by stacking two or more electrode assemblies.

### Negative Electrode

For example, a negative electrode for an all-solid-state battery may include a current collector and a negative electrode active material layer positioned on the current collector. The negative electrode active material layer includes a negative electrode active material, and may further include a binder, a conductive material, and/or a solid electrolyte.

The negative electrode active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include a carbon-based negative electrode active material, e.g., crystalline carbon, amorphous carbon, or a combination thereof. Examples of the crystalline carbon may include graphite such as amorphous, plate-shaped, flake-shaped, spherical, or fibrous natural graphite or artificial graphite, and examples of the amorphous carbon may include soft carbon or hard carbon, mesophase pitch carbide, and calcined coke.

As the alloy of the lithium metal, an alloy of lithium with one or more metals selected from Na, K, Rb, Cs, Fr, Be, Mg, Ca, Sr, Si, Sb, Pb, In, Zn, Ba, Ra, Ge, Al and Sn may be used.

A Si-based negative electrode active material or a Sn-based negative electrode active material may be used as a material capable of doping and dedoping lithium, the Si-based negative electrode active material may include silicon, silicon-carbon composite, SiOₓ (0<x<2), or an Si-Q alloy (The Q is an element selected from alkali metals, alkaline earth metals, Group 13 elements, Group 14 elements, Group 15 elements, Group 16 elements, transition metals, rare earth elements, and combinations thereof, but not Si), and the Sn-based negative electrode active material may include Sn, SnO₂, and an Sn—R alloy (The R is an element selected from the group consisting of alkali metals, alkaline earth metals, Group 13 elements, Group 14 elements, Group 15 elements, Group 16 elements, transition metals, rare earth elements, and combinations thereof, but not Sn), etc., and also at least one of these may be mixed with SiO₂. The element Q and the element R may each include at least one element selected from Mg, Ca, Sr, Ba, Ra, Sc, Y, Ti, Zr, Hf, Rf, V, Nb, Ta, Db, Cr, Mo, W, Sg, Pb, Pt, Cu, Ag, Au, Zn, Cd, B, Al, Ga, Sn, In, Tl, Ge, P, As, Sb, Bi, S, Se, Te, Po, and a combination thereof.

For example, the silicon-carbon composite may be a silicon-carbon composite including a core containing crystalline carbon and silicon particles and an amorphous carbon coating layer positioned on a surface of the core. The crystalline carbon may be artificial graphite, natural graphite, or a combination thereof. As a precursor of the amorphous carbon, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % based on a total weight of the silicon-carbon composite. In addition, a content of the crystalline carbon may be wt % to 70 wt % based on the total weight of the silicon-carbon composite, and a content of the amorphous carbon may be 20 wt % to 40 wt % based on the total weight of the silicon-carbon composite. Additionally, a thickness of the amorphous carbon coating layer may be 5 nm to 100 nm.

The average particle diameter (D50) of the silicon particles may be 10 nm to 20 μm, e.g., 10 nm to 500 nm. The silicon particles may exist in an oxidized form, and in this case, an atomic content ratio of Si:O in the silicon particles, which indicates a degree of oxidation, may be 99:1 to 33:67. The silicon particles may be particles of SiOₓ, and in this case, a range of x may be greater than 0 and less than 2 in SiOₓ. Herein, the average particle diameter (D50) is measured with a particle size analyzer using laser diffraction and indicates a diameter of particles with a cumulative volume of 50% by volume in the particle size distribution.

The Si-based negative electrode active material or Sn-based negative electrode active material may be used by mixing with a carbon-based negative electrode active material. A mixing ratio of the Si-based negative electrode active material or Sn-based negative electrode active material; and the carbon-based negative electrode active material may be in a weight ratio of 1:99 to 90:10.

A content of the negative electrode active material in the negative electrode active material layer may be 95 wt % to 99 wt % based on a total weight of the negative electrode active material layer.

In an embodiment, the negative electrode active material layer may further include a binder, and may further include a selectively conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to ensure that particles of the negative electrode active material adhere to each other and also to adhere the negative electrode active material to the current collector. The binder may include a non-water-soluble binder, a water-soluble binder, or a combination thereof.

The non-water-soluble binders may include, e.g., polyvinylchloride, carboxylated polyvinylchloride, polyvinylfluoride, polymers containing ethylene oxide, ethylene propylene copolymer, polystyrene, polyvinylpyrrolidone, polyurethane, polytetrafluoroethylene, polyvinylidene fluoride, polyethylene, polypropylene, polyamideimide, polyimide or a combination thereof.

Examples of the water-soluble binder may include a rubber binder or a polymer resin binder. The rubber-based binder may be selected from styrene-butadiene rubber, acrylated styrene-butadiene rubber, acrylonitrile-butadiene rubber, acryl rubber, butylrubber, fluorinerubber, and a combination thereof. The polymer resin binder may be selected from polyethyleneoxide, polyvinylpyrrolidone, polyphelohydrin, polyphosphazene, polyacrylonitrile, ethylenepropylenedienecopolymer, polyvinylpyridine, chlorosulfonated polyethylene, latex, polyesterresin, acrylresin, phenolresin, epoxy resin, polyvinylalcohol, and a combination thereof.

If a water-soluble binder is used as the negative binder, a thickener capable of imparting viscosity may be used together, and the thickener may include, e.g., a cellulose-based compound. The cellulose-based compound may include carboxymethyl cellulose, hydroxypropylmethyl cellulose, methyl cellulose, an alkali metal salt thereof, or a combination thereof. As the alkali metal, Na, K, or Li may be used. A content of the thickener may be 0.1 to 3 parts by weight based on 100 parts by weight of the negative electrode active material.

The conductive material may be used to provide conductivity to the electrode, and may include, e.g., a carbon-based material such as natural graphite, artificial graphite, carbon black, acetylene black, Ketjen black, carbon fiber, and carbon nanotubes; a metallic substance including copper, nickel, aluminum, silver, etc. and in the form of metal powder or metal fiber; a conductive polymer such as polyphenylene derivative; or a mixture thereof.

The negative electrode current collector may be selected from copper foil, nickel foil, stainless steel foil, titanium foil, nickel foam, copper foam, a polymer substrate coated with a conductive metal, and a combination thereof.

As another example, the negative electrode for an all-solid-state battery may be a precipitated negative electrode. The precipitated negative electrode refers to a negative electrode that does not contain a negative electrode active material if the battery is assembled, but lithium metal, etc. is deposited during battery charging and this acts as a negative electrode active material.

FIG. 2 illustrates a schematic cross-sectional view of an all-solid-state rechargeable battery including a precipitated negative electrode according to an embodiment. Referring to FIG. 2, a precipitated negative electrode 400′ may include a current collector 401 and a negative electrode coating layer 405 disposed on the current collector. In an all-solid-state battery having such a precipitated negative electrode 400′, initial charging begins in the absence of negative electrode active material, and during charging, high-density lithium metal is precipitated between the current collector 401 and the negative electrode coating layer 405 to form a lithium metal layer 404, which may serve as a negative electrode active material. Accordingly, in an all-solid-state battery that has been charged at least once, the precipitated negative electrode 400′ may include a current collector 401, a lithium metal layer 404 disposed on the current collector, and a negative electrode coating layer 405 positioned on the metal layer. The lithium metal layer 404 refers to a layer in which lithium metal, etc. is precipitated during the charging process of the battery, and may be referred to as a metal layer or a negative electrode active material layer.

The negative electrode coating layer 405 may contain a metal, a carbon material, or a combination thereof that acts as a catalyst.

The metal may include, e.g., gold, platinum, palladium, silicon, silver, aluminum, bismuth, tin, zinc, or a combination thereof, and may be formed of one of these or of several types of alloys. If the metal exists in particle form, its average particle diameter (D50) may be about 4 μm or less, e.g., 10 nm to 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, Denka black, Ketjen black, or a combination thereof.

If the negative electrode coating layer 405 includes both the metal and the carbon material, a mixing ratio of the metal and the carbon material may be, e.g., a weight ratio of 1:10 to 2:1. In this case, precipitation of lithium metal may be effectively promoted, and characteristics of the all-solid-state battery may be improved. For example, the negative electrode coating layer 405 may include a carbon material on which a catalyst metal is supported, or may include a mixture of metal particles and carbon material particles.

The negative electrode coating layer 405 may include the metal and amorphous carbon, for example, and in this case, precipitation of lithium metal can be effectively promoted.

The negative electrode coating layer 405 may further include a binder, and the binder may be a conductive binder. Additionally, the negative electrode coating layer 405 may further include general additives such as fillers, dispersants, and ion conductive materials.

A thickness of the negative electrode coating layer 405 may be, e.g., 100 nm to 20 μm, or 500 nm to 10 μm, or 1 μm to 5 μm.

For example, the precipitated negative electrode 400′ may further include a thin film on a surface of the current collector, that is, between the current collector and the negative electrode coating layer. The thin film may contain an element that can form an alloy with lithium. The element that can form an alloy with lithium may be, e.g., gold, silver, zinc, tin, indium, silicon, aluminum, bismuth, etc., and may be formed of one type or several types of alloys. The thin film may further flatten the precipitation form of the lithium metal layer 404 and may further improve the characteristics of the all-solid-state battery. The thin film may be formed by, e.g., vacuum deposition, sputtering, or plating methods. A thickness of the thin film may be, e.g., 1 nm to 500 nm.

### Solid Electrolyte Layer

The solid electrolyte layer 300 may include a sulfide-based solid electrolyte, an oxide-based solid electrolyte, etc. Specific details of the sulfide-based solid electrolyte and the oxide-based solid electrolyte are as described above.

In an example, the solid electrolyte included in the positive electrode 200 and the solid electrolyte included in the solid electrolyte layer 300 may include a same compound or different compounds. For example, if both the positive electrode 200 and the solid electrolyte layer 300 contain an azyrodite-type sulfide-based solid electrolyte, overall performance of the all-solid-state rechargeable battery may be improved. In addition, as an example, if both the positive electrode 200 and the solid electrolyte layer 300 include the above-described coated solid electrolyte, the all-solid-state rechargeable battery may realize high capacity and high energy density while realizing excellent initial efficiency and lifespan characteristics.

Meanwhile, the average particle diameter (D50) of the solid electrolyte included in the positive electrode 200 may be smaller than the average particle diameter (D50) of the solid electrolyte included in the solid electrolyte layer 300. In this case, overall performance may be improved by maximizing energy density of the all-solid-state battery and increasing mobility of lithium ions. For example, the average particle diameter (D50) of the solid electrolyte contained in the positive electrode 200 may be 0.1 μm to 1.0 μm, or 0.1 μm to 0.8 μm, and the average particle diameter (D50) of the solid electrolyte included in the solid electrolyte layer 300 may be 1.5 μm to 5.0 μm, or 2.0 μm to 4.0 μm, or 2.5 μm to 3.5 μm. If this particle size range is satisfied, the energy density of the all-solid-state rechargeable battery may be maximized and the transfer of lithium ions may be facilitated, thereby suppressing resistance, and thus improving the overall performance of the all-solid-state rechargeable battery. Herein, the average particle diameter (D50) of the solid electrolyte may be measured through a particle size analyzer using a laser diffraction method. Alternatively, the D50 may be calculated by selecting about 20 particles from a photomicroscope such as a scanning electron microscope, measuring the particle size, and obtaining the particle size distribution.

The solid electrolyte layer may further include a binder in addition to the solid electrolyte. In this case, the binder may be styrene butadiene rubber, polytetrafluoroethylene, polyvinylidene fluoride, polyethylene, acrylate polymer, or a combination thereof, but the present disclosure is not limited thereto, and anything used as a binder in the art may be used. The acrylate-based polymer may be, e.g., butyl acrylate, polyacrylate, polymethacrylate, or a combination thereof.

The solid electrolyte layer may be formed by adding a solid electrolyte to a binder solution, coating it on a base film, and drying it. A solvent for the binder solution may be isobutyryl isobutyrate, xylene, toluene, benzene, hexane, or a combination thereof. Since the solid electrolyte layer forming process is widely known in the field, detailed description will be omitted.

A thickness of the solid electrolyte layer may be, e.g., 10 μm to 150 μm.

The solid electrolyte layer may further include an alkali metal salt, and/or an ionic liquid, and/or a conductive polymer.

The alkali metal salt may be, e.g., a lithium salt. A content of the lithium salt in the solid electrolyte layer may be 1M or more, e.g., 1M to 4M. In this case, the lithium salt may improve ion conductivity by improving lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), Lithium bis(oxalato) borate (LiBOB), lithium oxalyldifluoroborate (LIODFB), Lithium difluoro(oxalato)borate (LiDFOB), lithium bis(trifluoro methanesulfonyl)imide, LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄ or a mixture thereof.

Additionally, the lithium salt may be an imide-based lithium salt, and for example, the imide-based lithium salt may include lithium bis(trifluoro methanesulfonyl)imide, LiTFSI, LiN(SO₂CF₃)₂ and lithium bis(fluorosulfonyl)imide, LiFSI, LiN(SO₂F)₂. The lithium salt may maintain or improve ionic conductivity by maintaining appropriate chemical reactivity with ionic liquid.

The ionic liquid has a melting point below room temperature, and refers to a salt that is in a liquid state at room temperature and consists of ions, or a room temperature molten salt.

The ionic liquid may be a compound containing a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof and b) one or more anions selected from BF₄—, PF₆—, AsF₆—, SbF₆—, AlCl₄—, HSO₄—, Cl₁O₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may include, e.g., one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. A solid electrolyte layer that satisfies the above range may maintain or improve ionic conductivity by improving an electrochemical contact area with the electrode. Accordingly, energy density, discharge capacity, and a rate characteristic of the all-solid-state battery may be improved.

The all-solid-state battery may be a unit battery with a structure of positive electrode/solid electrolyte layer/negative electrode, a bicell including a structure of positive electrode/solid electrolyte layer/negative electrode/solid electrolyte layer/positive electrode, or a stacked battery in which the structure of the unit cell is repeated.

A shape of the all-solid-state battery is not particularly limited, and may be, e.g., coin-shaped, button-shaped, sheet-shaped, stacked-type, cylindrical-shaped, flat-shaped, etc. Additionally, the all-solid-state battery may also be applied to large batteries used in electric vehicles, etc. For example, the all-solid-state battery may also be used in hybrid vehicles such as plug-in hybrid electric vehicles (PHEV). In addition, it may be used in fields that require large amounts of power storage, e.g., electric bicycles or power tools.

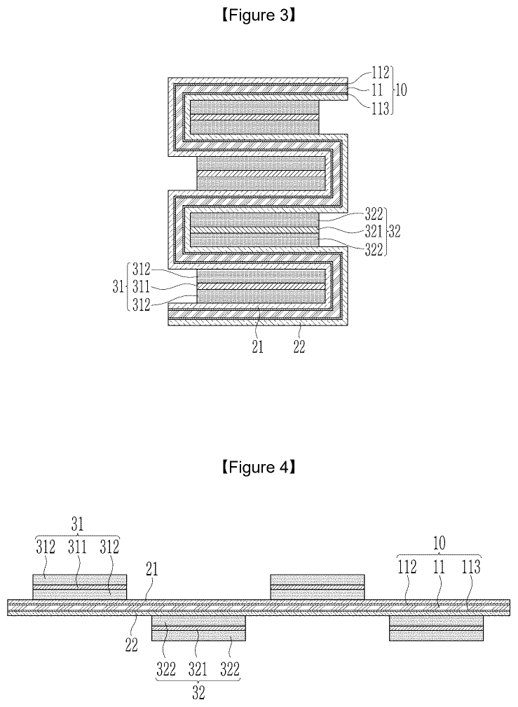

FIG. 3 illustrates a cross-sectional view of an all-solid-state rechargeable battery according to a first embodiment of the present disclosure,

FIG. 4 illustrates a cross-sectional view of a state before zigzag stacking a negative electrode, a first solid electrolyte layer, a second solid electrolyte layer, a first positive electrode, and a second positive electrode to manufacture the all-solid-state rechargeable battery of FIG. 3, and

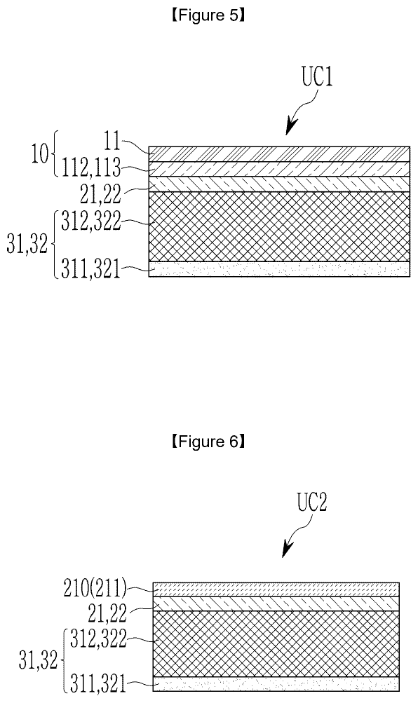

FIG. 5 illustrates a cross-sectional view of a unit cell formed of a negative electrode, a solid electrolyte layer, and a positive electrode in FIG. 4.

Referring to FIGS. 3 and 4, the all-solid-state rechargeable battery of the first embodiment may include a band-shaped negative electrode 10, a first solid electrolyte layer 21 and a second solid electrolyte layer 22 respectively provided at opposite sides of the negative electrode 10, and first and second positive electrodes 31 and 32 respectively stacked on the first and second solid electrolyte layers 21 and 22. The second positive electrode 32 may be spaced apart from the first positive electrode 31 in a longitudinal direction of the negative electrode 10.

The negative electrode 10 may be formed long in a band shape to be folded and stacked in a zigzag shape, and the first positive electrode 31 and the second positive electrode 32 may be alternately disposed between the folded and stacked negative electrodes 10. That is, from the bottom to the top in FIG. 3, the negative electrode 10, the first positive electrode 31, the negative electrode 10, the second positive electrode 32, and the negative electrode 10 may be repeatedly stacked and positioned.

Each of the first positive electrode 31 and the second positive electrode 32 may include a thin film metal positive electrode substrate 311 and 321, and a first positive electrode active material layer 312 and a second positive electrode active material layer 322 formed at opposite sides of the positive electrode substrate 311 and 321.

The negative electrode 10 may include functional layers 112 and 113 formed at opposite sides of the negative electrode substrate 11 of a thin film metal. The first solid electrolyte layer 21 and the second solid electrolyte layer 22 may each be formed on the respective functional layers 112 and 113 at opposite sides of the negative electrode substrate 11.

In an all-solid-state rechargeable battery in a zigzag stacked state, each of the first solid electrolyte layer 21 and the second solid electrolyte layer may alternately correspond to a side end portion of the first positive electrode 31 and a side end portion of the second positive electrode 32.

The functional layers 112 and 113 of the negative electrode 10 may be formed as a coating layer of a polymer or a ceramic material on the negative electrode substrate 11. When the functional layers 112 and 113 and the first and second solid electrolyte layers 21 and 22 are provided on the negative electrode 10, an all-solid-state rechargeable battery may be formed.

Furthermore, the functional layers 112 and 113 may be formed by bonding a separation layer to the negative electrode substrate 11. In this case, the first and second solid electrolyte layers 21 and 22 are not provided, so a lithium ion rechargeable battery may be formed.

Referring to FIG. 5, in the all-solid-state rechargeable battery of the first embodiment, the unit cell UC1 may be formed between the negative electrode substrate 11 and the positive electrode substrate 311. That is, the unit cell UC1 may be formed by a stacked structure of the first positive electrode 31, the positive electrode active material layer 312, the first solid electrolyte layer 21, the functional layer 112, and the negative electrode substrate 11.

The all-solid-state rechargeable battery having a precipitated negative electrode 10 may start initial charging in the absence of a negative electrode active material, during charging, a high-density lithium metal, etc. may be precipitated between the negative electrode substrate 11 and the functional layers 112 and 113 to form a lithium metal layer, and the lithium metal layer may act as a negative electrode active material.

Hereinafter, various embodiments of the present disclosure will be described. Descriptions of configurations identical to those described in the above-described embodiments will be omitted, and descriptions of different configurations will be described.

FIG. 6 illustrates a cross-sectional view of a unit cell formed of a negative electrode, a solid electrolyte layer, and a positive electrode in an all-solid-state rechargeable battery according to a second embodiment of the present disclosure. Referring to FIG. 6, in the all-solid-state rechargeable battery of the second embodiment, the unit cell UC2 may be formed by a stacked structure of the positive electrode substrate 311 of the first positive electrode 31, the first positive electrode active material layer 312, the first solid electrolyte layer 21, and the negative electrode substrate 211 of the negative electrode 210.

The negative electrode 210 may be formed of lithium metal, and may not have the functional layer of the first embodiment. Accordingly, the first solid electrolyte layer 21 and the second solid electrolyte layer 22 may be formed on lithium metal on opposite surfaces.

The all-solid-state rechargeable battery having a precipitated negative electrode 210 may start initial charging in the absence of a negative electrode active material, during charging, a lithium metal layer may be formed by depositing high-density lithium metal, etc. on the negative electrode substrate 11 formed of lithium metal, and the lithium metal layer may act as a negative electrode active material.

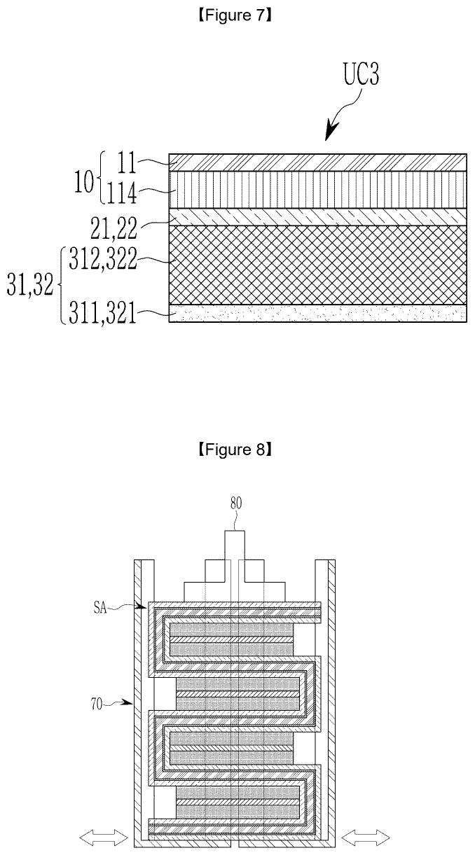

FIG. 7 illustrates a cross-sectional view of a unit cell formed of a negative electrode, a solid electrolyte layer, and a positive electrode in an all-solid-state rechargeable battery according to a third embodiment of the present disclosure.

Referring to FIG. 7, in the all-solid-state rechargeable battery of the third embodiment, the unit cell UC3 may be formed by a stacked structure of the positive electrode substrate 311 of the first positive electrode 31, the first positive electrode active material layer 312, the first solid electrolyte layer 21, a metal pattern 114, and the negative electrode substrate 11.

The negative electrode 310 may include the metal pattern 114 formed on opposite surfaces of the negative electrode substrate 11. Accordingly, the first solid electrolyte layer 21 and the second solid electrolyte layer 22 may be respectively formed on the metal patterns 114 on opposite surfaces. The metal pattern 114 may be formed as a lithium metal pattern or an aluminum metal pattern.

The all-solid-state rechargeable battery having a precipitated negative electrode 210 may start initial charging in the absence of a negative electrode active material, during charging, a high-density lithium metal, etc. may be precipitated between the negative electrode substrate 11 in contact with an empty space inside the metal pattern 114 and the empty space inside the metal pattern 114 so that a lithium metal layer is formed to minimize thickness change, and the lithium metal layer may act as a negative electrode active material. Furthermore, when the metal pattern 114 reacts with lithium, some alloys may be formed. For example, if the metal pattern is formed of a metal such as aluminum (Al) or silicon (Si), it may react with lithium to form some alloys.

FIG. 8 illustrates a cross-sectional view showing an operation of forming a stack in a manufacturing method for an all-solid-state rechargeable battery using a manufacturing apparatus for an all-solid-state rechargeable battery according to an embodiment of the present disclosure,

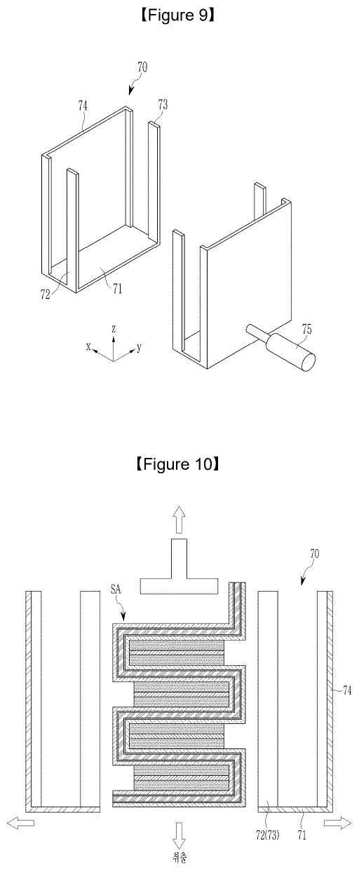

FIG. 9 illustrates a perspective view of a stack guide applied to the manufacturing apparatus of FIG. 8,

FIG. 10 illustrates a cross-sectional view of an all-solid-state rechargeable battery being removed in a manufacturing method using the manufacturing apparatus of FIG. 8, and

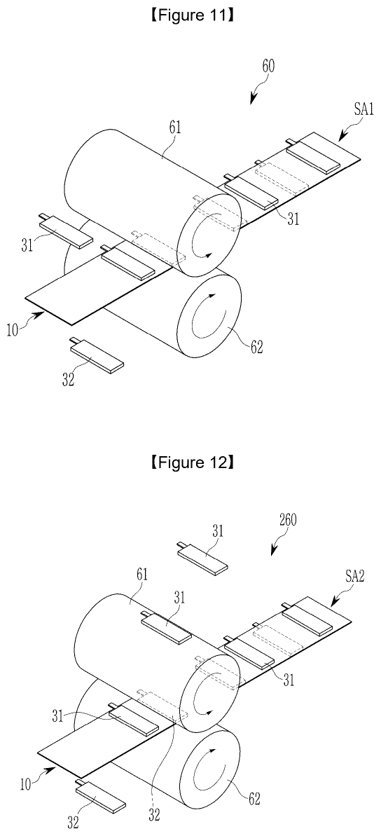

FIG. 11 illustrates a perspective view showing a first embodiment forming a stack in a manufacturing method for an all-solid-state rechargeable battery using a manufacturing apparatus for an all-solid-state rechargeable battery according to an embodiment of the present disclosure.

Referring to FIGS. 8 to 11, the manufacturing apparatus for an all-solid-state rechargeable battery according to an embodiment of the present disclosure may include a stack forming portion 60, a pair of stack guides 70, an actuator 75, and a high temperature press 80. For convenience, the all-solid-state rechargeable battery according to the first embodiment of FIGS. 3 to 5 will be described as an example.

The stack forming portion 60 may be configured such that the negative electrodes 10 are folded and stacked in a zigzag manner, and the first positive electrode 31 and the second positive electrode 32 may be alternately arranged between the folded and stacked positions to form a stacking assembly SA.

Referring to FIG. 9, the stack guide 70 may be formed as a pair to support a lower surface and a side surface of the stack SA, and they may be arranged oppositely at opposite sides in a zigzag width direction. As an example, the stack guide 70 may include a lower plate 71, a front plate 72, a rear plate 73, and a side plate 74 to three-dimensionally support the stack SA.

The lower plate 71 may be formed to correspond to a lower surface of the stack SA. The front plate 72 and the rear plate 73 may extend upward from the lower plate 71 to support front and rear surfaces of the stack SA at an adjacent side of the stack SA on the lower plate 71. The side plate 74 may extend upward from the lower plate 71 to support a side surface of the stack SA from the lower plate 71.

The actuator 75 may be connected to the stack guide 70 to control movement of the stack guides 70 in a width direction (x-axis direction). That is, the actuator 75 may be connected to the side plate 74 to operate in a flexible manner, so that the stack guide 70 may be moved forward and backward in the x-axis direction.

The actuator 75 may be identically connected to the pair of stack guides 70. Furthermore, the actuator 75 may be formed only at one of the pair of stack guides 70, so that one may be used as a fixed type and the other as a movable type.

Again referring to FIG. 8, the high temperature press 80 may press the stack SA supported on the stack guide 70. In this case, the lower plate 71, the front plate 72, the rear plate 73, and the side plate 74 of the stack guide 70 may set a shape of the stack SA.

Accordingly, the positive electrode substrate 311, the first positive electrode active material layer 312, the first solid electrolyte layer 21, the functional layer 112, the negative electrode substrate 11, the functional layer 113, the second solid electrolyte layer 22, the second positive electrode active material layer 322 and the positive electrode substrate 321 of the second positive electrode 31 forming the unit cell UC1 within the stack SA form a close bonding structure.

Referring again to FIG. 11, the stack forming portion 60 of the first embodiment may include an upper roll 61 and a lower roll 62. The stack forming portion 60 may stack the first positive electrode 31 by injecting it into the first solid electrolyte layer 21 provided on a first surface of the band-shaped negative electrode 10 that advances between the upper roll 61 and the lower roll 62, and may stack the second positive electrode 32 by injecting it into the second solid electrolyte layer 22 provided on a second surface of the negative electrode 10 and spaced apart from the first positive electrode 31 in a length direction of the negative electrode 10, and may pressurize it while advancing together with the negative electrode 10. Accordingly, the stacked first positive electrode 31, first solid electrolyte layer 21, negative electrode 10, second solid electrolyte layer 22, and second positive electrode 32 may pass between the upper roll 61 and the lower roll 62 of the stack forming portion 60, thereby forming a stack SA1 in a state before bending (see FIG. 4).

A distance between the first and second positive electrodes 31 and 32 in a longitudinal direction of the negative electrode 10 may correspond to a pitch of zigzag folding stacking. The stack forming portion 60 may include a separate feeder (not shown) for feeding the first positive electrode 31 and the second positive electrode 32 as individual sheets to opposite surfaces of the negative electrode 10, respectively.

Hereinafter, various embodiments of the stack forming portion 60 will be described. Descriptions of configurations identical to those described in the above-described embodiments will be omitted, and descriptions of different configurations will be described.

FIG. 12 illustrates a perspective view showing a second embodiment forming a stack in a manufacturing method for an all-solid-state rechargeable battery using a manufacturing apparatus for an all-solid-state rechargeable battery according to an embodiment of the present disclosure.

Referring again to FIG. 12, a stack forming portion 260 of the second embodiment may include an upper roll 61 and a lower roll 62. The stack forming portion 260 may provide the first positive electrode 31 by attaching it to the upper roll 61 and the second positive electrode 32 by attaching it to the lower roll 62. The stack forming portion 260 may stack the first positive electrode 31 on the first solid electrolyte layer 21 provided on a first surface of the negative electrode 10 on which the band-shaped negative electrode 10 advances, and may stack the second positive electrode 32 on the second solid electrolyte layer 22 spaced apart from the first positive electrode 31 in the longitudinal direction of the negative electrode 10, and may pressurize it with the upper roll 61 and the lower roll 62 while advancing together with the negative electrode 10. Accordingly, the stacked first positive electrode 31, first solid electrolyte layer 21, negative electrode 10, second solid electrolyte layer 22, and second positive electrode 32 may pass between the upper roll 61 and the lower roll 62 of the stack forming portion 260, thereby forming a stack SA2 in a state before bending.

A distance between the first and second positive electrodes 31 and 32 in a longitudinal direction of the negative electrode 10 may correspond to a pitch of zigzag folding stacking. The stack forming portion 260 may include a separate feeder (not shown) for feeding the first positive electrode 31 and the second positive electrode 32 as individual sheets to the upper roll 61 and the lower roll 62, respectively.

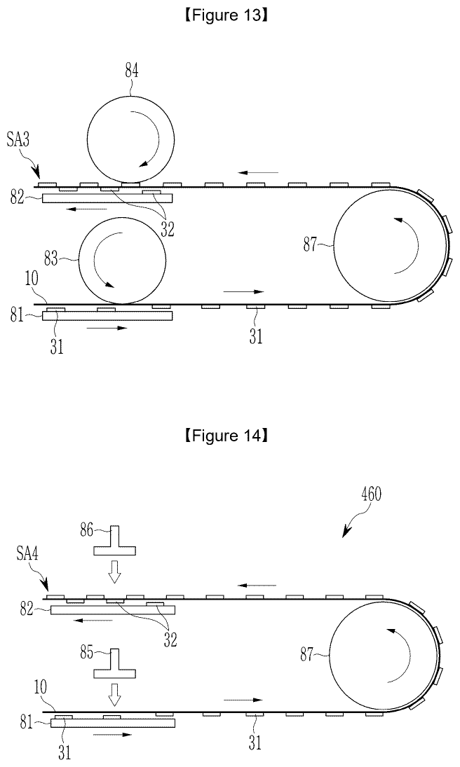

FIG. 13 illustrates a side view showing a third embodiment forming a stack in a manufacturing method for an all-solid-state rechargeable battery using a manufacturing apparatus for an all-solid-state rechargeable battery according to an embodiment of the present disclosure. Referring to FIG. 13, a stack forming portion 360 of the third embodiment may provide the first positive electrode 31 by attaching it to a first plate 81 such that the first positive electrode 31 is stacked on the first solid electrolyte layer 21 provided on a first surface of the negative electrode 10 on which the band-shaped negative electrode 10 advances, and may pressurize and attach the first positive electrode 31 to the first surface of the negative electrode 10 by pressure with a first roll 83.

Furthermore, the stack forming portion 360 may provide the second positive electrode 32 by attaching it to a second plate 82 such that the second positive electrode 32 is stacked on the second solid electrolyte layer 22, spaced apart from the first positive electrode 31 in the longitudinal direction of the negative electrode 10, and may pressurize and attach the second positive electrode 32 to a second surface of the negative electrode 10 by pressure with a second roll 84.

Accordingly, the stacked first positive electrode 31, first solid electrolyte layer 21, negative electrode 10, second solid electrolyte layer 22, and second positive electrode 32 may pass between the first and second plates 81 and 82 and the first and second rolls 83 and 84 of the stack forming portion 360, thereby forming a stack SA3 in a state before bending.

The stack forming portion 360 may be provided with a return roll 87 so that an advancing direction of the first plate 81 is opposite to an advancing direction of the second plate 82, thereby shortening a length along which the negative electrode 10 advances in the stack forming portion 360.

FIG. 14 illustrates a side view showing a fourth embodiment forming a stack in a manufacturing method for an all-solid-state rechargeable battery using a manufacturing apparatus for an all-solid-state rechargeable battery according to an embodiment of the present disclosure. Referring to FIG. 14, a stack forming portion 460 of the fourth embodiment may provide the first positive electrode 31 by attaching it to the first plate 81 such that the first positive electrode 31 is stacked on the first solid electrolyte layer 21 provided on a first surface of the negative electrode 10 on which the band-shaped negative electrode 10 advances, and may pressurize and attach the first positive electrode 31 to the first surface of the negative electrode 10 by pressure of a first press 85.

Furthermore, the stack forming portion 460 may provide the second positive electrode 32 by attaching it to a second plate 82 such that the second positive electrode 32 is stacked on the second solid electrolyte layer 22, spaced apart from the first positive electrode 31 in the longitudinal direction of the negative electrode 10, and may pressurize and attach the second positive electrode 32 to a second surface of the negative electrode 10 by pressure of a second press 86.

Accordingly, the stacked first positive electrode 31, first solid electrolyte layer 21, negative electrode 10, second solid electrolyte layer 22, and second positive electrode 32 may pass between the first and second plates 81 and 82 and the first and second presses 85 and 86 of the stack forming portion 460, thereby forming a stack SA4 in a state before bending.

The stack forming portion 460 may be provided with a return roll 87 so that an advancing direction of the first plate 81 is opposite to an advancing direction of the second plate 82, thereby shortening a length along which the negative electrode 10 advances in the stack forming portion 460.

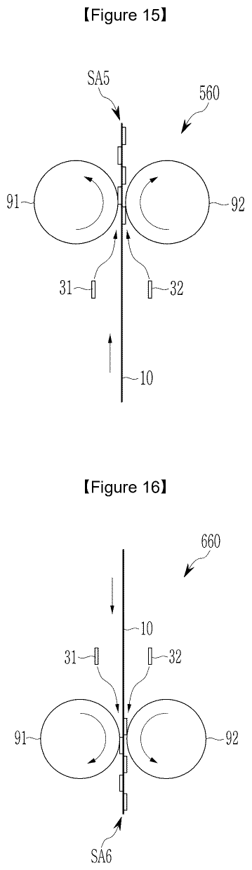

FIG. 15 illustrates a side view showing a fifth embodiment forming a stack in a manufacturing method for an all-solid-state rechargeable battery using a manufacturing apparatus for an all-solid-state rechargeable battery according to an embodiment of the present disclosure. Referring to FIG. 15, a stack forming portion 560 of the fifth embodiment may provide the first positive electrode 31 between a left roll 91 and the first solid electrolyte layer 21 such that the first positive electrode 31 is stacked on the first solid electrolyte layer 21 provided on a first surface of the negative electrode 10 on which the band-shaped negative electrode 10 advances upward.

Furthermore, the stack forming portion 560 may provide the second positive electrode 32 between a right roll 92 and the second solid electrolyte layer 22 such that the second positive electrode 32 is stacked on the second solid electrolyte layer 22, spaced apart from the first positive electrode 31 in the longitudinal direction of the negative electrode 10.

Furthermore, the stacked first positive electrode 31, first solid electrolyte layer 21, negative electrode 10, second solid electrolyte layer 22, and second positive electrode 32 may pass between the left roll 91 and the right roll 92, so a stack SA5 in a pre-bending state is formed by pressure of the left roll 91 and the right roll 92.

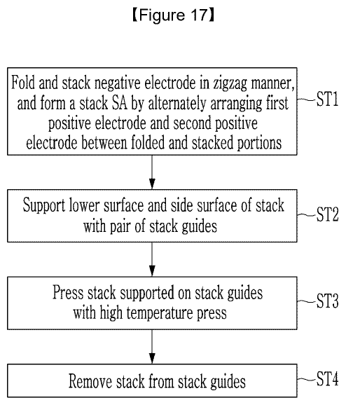

FIG. 16 illustrates a side view showing a sixth embodiment forming a stack in a manufacturing method for an all-solid-state rechargeable battery using a manufacturing apparatus for an all-solid-state rechargeable battery according to an embodiment of the present disclosure. Referring to FIG. 16, a stack forming portion 660 of the sixth embodiment may provide the first positive electrode 31 between a left roll 91 and the first solid electrolyte layer 21 such that the first positive electrode 31 is stacked on the first solid electrolyte layer 21 provided on a first surface of the negative electrode 10 on which the band-shaped negative electrode 10 advances upward.

Furthermore, the stack forming portion 660 may provide the second positive electrode 32 between a right roll 92 and the second solid electrolyte layer 22 such that the second positive electrode 32 is stacked on the second solid electrolyte layer 22, spaced apart from the first positive electrode 31 in the longitudinal direction of the negative electrode 10.

Furthermore, the stacked first positive electrode 31, first solid electrolyte layer 21, negative electrode 10, second solid electrolyte layer 22, and second positive electrode 32 may pass between the left roll 91 and the right roll 92, so a stack SA6 in a pre-bending state is formed by pressure of the left roll 91 and the right roll 92.

Hereinafter, a manufacturing method for an all-solid-state rechargeable battery using a manufacturing apparatus for an all-solid-state rechargeable battery according to an embodiment is described.

FIG. 17 illustrates a flowchart of a manufacturing method for an all-solid-state rechargeable battery according to an embodiment of the present disclosure. Referring to FIGS. 8 to 11 and 17, the manufacturing method for an all-solid-state rechargeable battery of an embodiment includes a first operation ST1, a second operation ST2, a third operation ST3, and a fourth operation ST4.

The first operation ST1 may include a band-shaped negative electrode 10, a first solid electrolyte layer 21 and a second solid electrolyte layer 22 respectively provided at opposite surfaces of the negative electrode 10, a first positive electrode 31 stacked on the first solid electrolyte layer 21, and a second positive electrode 32 stacked on the second solid electrolyte layer 22 and spaced apart from the first positive electrode 31 in a longitudinal direction of the negative electrode 10, may fold and stack the negative electrode 10 in a zigzag manner, and may form a stack SA by alternately arranging the first positive electrode 31 and the second positive electrode 32 between the folded and stacked portions.

The second operation ST2 may support a lower surface and a side surface of the stack SA with a pair of stack guides 70 that are arranged oppositely at opposite sides in a zigzag width direction to be advanced by an actuator 75. The third operation ST3 may press the stack SA supported on the stack guides 70 with a high temperature press 80. The fourth operation ST4 may remove the stack SA from the stack guides 70 by retracting the stack guides 70 supporting the lower surface and the side surface of the completely pressed stack SA by the actuator 75.

Referring to FIG. 11, in a manufacturing method of a first embodiment, the first operation ST1 may include an 11^{th} operation of stacking the first positive electrode 31 on the first solid electrolyte layer 21 provided on a first surface of the negative electrode 10 on which the band-shaped negative electrode 10 advances, a 12^{th} operation of stacking the second positive electrode 32 on the second solid electrolyte layer 22 spaced apart from the first positive electrode 31 in the longitudinal direction of the negative electrode 10, and a 13^{th} operation of pressurizing the first positive electrode 31, the negative electrode 10, and the second positive electrode 32 with an upper roll 61 and a lower roll 62. Accordingly, the first positive electrode 31, the negative electrode 10, and the second positive electrode 32 may form a stack SA1 in a state before folding.

Referring to FIG. 12, in a manufacturing method of a second embodiment, the first operation ST1 may include an 11^{th} operation of attaching the first positive electrode 31 to the upper roll 61 and providing it such that the first positive electrode 31 is stacked on the first solid electrolyte layer 21 provided on a first surface of the negative electrode 10 on which the band-shaped negative electrode 10 advances, a 12^{th} operation of attaching the second positive electrode 32 to the lower roll 62 and proving it such that the second positive electrode 32 is stacked on the second solid electrolyte layer 22 spaced apart from the first positive electrode 31 in the longitudinal direction of the negative electrode 10, and a 13^{th} operation of pressurizing the first positive electrode 31, the negative electrode 10, and the second positive electrode 32 with the upper roll 61 and the lower roll 62. Accordingly, the first positive electrode 31, the negative electrode 10, and the second positive electrode 32 may form a stack SA2 in a state before folding.

Referring to FIG. 13, in a manufacturing method of a third embodiment, the first operation ST1 may include an 11^{th} operation of attaching the first positive electrode 31 to a first plate 81 and providing it such that the first positive electrode 31 is stacked on the first solid electrolyte layer 21 provided on a first surface of the negative electrode 10 on which the band-shaped negative electrode 10 advances, a 12^{th} operation of pressurizing and attaching the first positive electrode 31 to a first surface of the negative electrode 10 by pressure between the first plate 81 and a first roll 83, a 13^{th} operation of attaching the second positive electrode 32 to a second plate 82 and providing it such that the second positive electrode 32 is stacked on the second solid electrolyte layer 22 while being spaced apart from the first positive electrode 31 in the longitudinal direction of the negative electrode 10, and a 14^{th} operation of pressurizing and attaching the second positive electrode 32 to a second surface of the negative electrode 10 by applying pressure between the second plate 82 and a second roll 84. Accordingly, the first positive electrode 31, the negative electrode 10, and the second positive electrode 32 may form a stack SA3 in a state before folding.

Referring to FIG. 14, in a manufacturing method of a fourth embodiment, the first operation may include an 11^{th} operation of attaching the first positive electrode 31 to a first plate 81 and providing it such that the first positive electrode 31 is stacked on the first solid electrolyte layer 21 provided on a first surface of the negative electrode 10 on which the band-shaped negative electrode 10 advances, a 12^{th} operation of pressurizing and attaching the first positive electrode 31 to a first surface of the negative electrode 10 by pressure between the first plate 81 and a first press 85, a 13^{th} operation of attaching the second positive electrode 32 to a second plate 82 and providing it such that the second positive electrode 32 is stacked on the second solid electrolyte layer 22 while being spaced apart from the first positive electrode 31 in the longitudinal direction of the negative electrode 10, and a 14^{th} operation of pressurizing and attaching the second positive electrode 32 to a second surface of the negative electrode 10 by applying pressure between the second plate 82 and a second press 86. Accordingly, the first positive electrode 31, the negative electrode 10, and the second positive electrode 32 may form a stack SA4 in a state before folding.

Referring to FIG. 15, in a manufacturing method of a fifth embodiment, the first operation ST1 may include an 11^{th} operation of providing the first positive electrode 31 between a left roll 91 and the first solid electrolyte layer 21 such that the first positive electrode 31 is stacked on the first solid electrolyte layer 21 provided on a first surface of the negative electrode 10 on which the band-shaped negative electrode 10 advances upward, a 12^{th} operation of providing the second positive electrode 32 between a right roll 92 and the second solid electrolyte layer 22 such that the second positive electrode 32 is stacked on the second solid electrolyte layer 22 spaced apart from the first positive electrode 31 in the longitudinal direction of the negative electrode 10, and a 13^{th} operation of pressurizing the first positive electrode 31, the negative electrode 10, and the second positive electrode 32 with the left roll 91 and the right roll 92. Accordingly, the first positive electrode 31, the negative electrode 10, and the second positive electrode 32 may form a stack SA5 in a state before folding.

Referring to FIG. 16, in a manufacturing method of a sixth embodiment, the first operation ST1 may include an 11^{th} operation of providing the first positive electrode 31 between the left roll 91 and the first solid electrolyte layer 21 such that the first positive electrode 31 is stacked on the first solid electrolyte layer 21 provided on a first surface of the negative electrode 10 on which the band-shaped negative electrode 10 advances downward, a 12^{th} operation of providing the second positive electrode 32 between the right roll 92 and the second solid electrolyte layer 22 such that the second positive electrode 32 is stacked on the second solid electrolyte layer 22 spaced apart from the first positive electrode 31 in the longitudinal direction of the negative electrode 10, and a 13^{th} operation of pressurizing the first positive electrode 31, the negative electrode 10, and the second positive electrode 32 with the left roll 91 and the right roll 92. Accordingly, the first positive electrode 31, the negative electrode 10, and the second positive electrode 32 may form a stack SA6 in a state before folding.

The above description is only one embodiment for implementing the all-solid-state rechargeable battery according to the present disclosure, and the present disclosure is not limited to the above-described embodiment, and as claimed in the following claims, it will be understood that the technical spirit of the present disclosure encompasses a range in which various modifications can be implemented without departing from the gist of the present disclosure.

Description of Symbols

| | |
|---|---|
| 10: negative electrode | 21: first solid electrolyte layer |
| 22: second solid electrolyte layer | 31, 32: first, second positive electrode |
| 60: stack forming portion | 61: upper roll |
| 62: lower roll | 70: stack guide |
| 71: lower plate | 72: front plate |
| 73: rear plate | 74: side plate |
| 75: actuator | 80: high temperature press |
| 81, 82: first, second plate | 83: first roll |
| 84: second roll | 85: first press |
| 86: second press | 87: return roll |
| 91: left roll | 92: right roll |
| 112, 113: functional layer | 114: metal pattern |
| 210: negative electrode | 260: stack forming portion |
| 311, 321: positive electrode | 312, 322: first, second positive |
| substrate | electrode active material layer |
| 360: stack forming portion | 460: stack forming portion |
| 560: stack forming portion | 660: stack forming portion |
| UC1: unit cell | UC2: unit cell |
| UC3: unit cell | SA: stack |
| SA1: stack | SA2: stack |
| SA3: stack | SA4: stack |
| SA5: stack | SA6: stack |

1. An all-solid-state rechargeable battery comprising:
a band-shaped negative electrode;
a first solid electrolyte layer and a second solid electrolyte layer provided on opposite surfaces of the negative electrode;
a first positive electrode stacked on the first solid electrolyte layer; and
a second positive electrode stacked on the second solid electrolyte layer and spaced apart from the first positive electrode in a longitudinal direction of the negative electrode,
wherein the negative electrode is folded and stacked in a zigzag pattern, and
the first positive electrode and the second positive electrode are alternately arranged between folded and stacked portions.

2. The all-solid-state rechargeable battery of claim 1, wherein
each of the first positive electrode and the second positive electrode includes a positive electrode substrate,
a first positive electrode active material layer and a second positive electrode active material layer formed on opposite surfaces of the positive electrode substrate,
the negative electrode includes a functional layer formed on opposite surfaces of the negative electrode substrate, and
the first solid electrolyte layer and the second solid electrolyte layer are respectively formed on functional layers on opposite surfaces.

3. (canceled)

4. The all-solid-state rechargeable battery of claim 2, wherein
each of the first solid electrolyte layer and the second solid electrolyte layer alternately corresponds to a side end portion of the first positive electrode and a side end portion of the second positive electrode.

5. The all-solid-state rechargeable battery of claim 2, wherein
the functional layers are formed as a coating layer of a polymer or a ceramic material on the negative electrode substrate, or
the functional layers are formed by bonding a separation layer to the negative electrode substrate.

6. (canceled)

7. The all-solid-state rechargeable battery of claim 1, wherein
the negative electrode is formed from lithium metal, and
the first solid electrolyte layer and the second solid electrolyte layer are respectively formed on lithium metal on opposite surfaces.

8. The all-solid-state rechargeable battery of claim 1, wherein
the negative electrode includes a metal pattern formed on opposite surfaces of the negative electrode substrate, and
the first solid electrolyte layer and the second solid electrolyte layer are formed on metal patterns on opposite surfaces.

9. A manufacturing apparatus for an all-solid-state rechargeable battery, the apparatus comprising:
a stack forming portion configured to include a band-shaped negative electrode, a first solid electrolyte layer and a second solid electrolyte layer provided on opposite surfaces of the negative electrode, a first positive electrode stacked on the first solid electrolyte layer, and a second positive electrode stacked on the second solid electrolyte layer and spaced apart from the first positive electrode in a longitudinal direction of the negative electrode, wherein the negative electrode is folded and stacked in a zigzag manner, and the first positive electrode and the second positive electrode are alternately arranged between folded and stacked portions to form a stack;
a pair of stack guides formed to support lower and side surfaces of the stack and arranged oppositely at opposite sides in a zigzag width direction;
an actuator connected to the stack guide to control movement of the stack guide in the width direction; and
a high temperature press configured to press the stack supported on the stack guide.

10. (canceled)

11. The manufacturing apparatus of claim 7, wherein
the stack forming portion stacks the first positive electrode on the first solid electrolyte layer provided on a first surface of the negative electrode on which the band-shaped negative electrode advances, and stacks the second positive electrode on the second solid electrolyte layer spaced apart from the first positive electrode in the longitudinal direction of the negative electrode, and pressurizes it with an upper roll and a lower roll.

12. The manufacturing apparatus of claim 7, wherein
the stack forming portion includes
an upper roll configured to provide the first positive electrode by attaching it thereto, and
a lower roll configured to provide the second positive electrode spaced apart from the first positive electrode in the longitudinal direction of the negative electrode by attaching it thereto, and
the stack forming portion stacks the first positive electrode on the first solid electrolyte layer provided on a first surface of the negative electrode on which the band-shaped negative electrode advances, and stacks the second positive electrode on the second solid electrolyte layer spaced apart from the first positive electrode in the longitudinal direction of the negative electrode, and pressurize it with the upper roll and the lower roll.

13. The manufacturing apparatus of claim 7, wherein
the stack forming portion provides the first positive electrode by attaching it to a first plate such that the first positive electrode is stacked on the first solid electrolyte layer provided on a first surface of the negative electrode on which the band-shaped negative electrode advances, and pressurizes and attaches the first positive electrode to the first surface of the negative electrode by pressure with a first roll, and
the stack forming portion provides the second positive electrode by attaching it to a second plate such that the second positive electrode is stacked on the second solid electrolyte layer, spaced apart from the first positive electrode in the longitudinal direction of the negative electrode, and pressurizes and attaches the second positive electrode to a second surface of the negative electrode 10 by pressure with a second roll.

14. The manufacturing apparatus of claim 7, wherein
the stack forming portion provides the first positive electrode by attaching it to a first plate such that the first positive electrode is stacked on the first solid electrolyte layer provided on a first surface of the negative electrode on which the band-shaped negative electrode advances, and pressurizes and attaches the first positive electrode to the first surface of the negative electrode by pressure of a first press, and
the stack forming portion provides the second positive electrode by attaching it to a second plate such that the second positive electrode is stacked on the second solid electrolyte layer, spaced apart from the first positive electrode in the longitudinal direction of the negative electrode, and pressurizes and attaches the second positive electrode to a second surface of the negative electrode 10 by pressure of a second press.

15. The manufacturing apparatus of claim 7, wherein
the stack forming portion provides the first positive electrode between a left roll and the first solid electrolyte layer such that the first positive electrode is stacked on the first solid electrolyte layer provided on a first surface of the negative electrode on which the band-shaped negative electrode advances upward, and
the stack forming portion provides the second positive electrode between a right roll and the second solid electrolyte layer such that the second positive electrode is stacked on the second solid electrolyte layer spaced apart from the first positive electrode in the longitudinal direction of the negative electrode, to apply pressure with the left roll and the right roll.

16. The manufacturing apparatus of claim 7, wherein
the stack forming portion provides the first positive electrode between a left roll and the first solid electrolyte layer such that the first positive electrode is stacked on the first solid electrolyte layer provided on a first surface of the negative electrode on which the band-shaped negative electrode advances downward, and
the stack forming portion provides the second positive electrode between a right roll and the second solid electrolyte layer such that the second positive electrode is stacked on the second solid electrolyte layer spaced apart from the first positive electrode in the longitudinal direction of the negative electrode, to apply pressure with the left roll and the right roll.

17. A manufacturing method for an all-solid-state rechargeable battery, the method comprising:
a first operation of including a band-shaped negative electrode, a first solid electrolyte layer and a second solid electrolyte layer provided on opposite surfaces of the negative electrode, a first positive electrode stacked on the first solid electrolyte layer, and a second positive electrode stacked on the second solid electrolyte layer and spaced apart from the first positive electrode in a longitudinal direction of the negative electrode, folding and stacking the negative electrode in a zigzag manner, and alternately arranging the first positive electrode and the second positive electrode between folded and stacked portions to form a stack;
a second operation of supporting a lower surface and a side surface of the stack with a pair of stack guide that are arranged oppositely at opposite sides in a zigzag width direction to be advanced by an actuator;
a third operation of pressing the stack supported on the stack guides with a high temperature press; and
a fourth operation of removing the stack from the stack guides by retracting the stack guides supporting the lower and side surfaces of the completely pressed stack by the actuator.

18. The manufacturing method of claim 14, wherein
the first operation includes
an 11^{th} operation of stacking the first positive electrode on the first solid electrolyte layer 21 provided on a first surface of the negative electrode on which the band-shaped negative electrode advances,
a 12^{th} operation of stacking the second positive electrode on the second solid electrolyte layer spaced apart from the first positive electrode in the longitudinal direction of the negative electrode, and
a 13^{th} operation of pressurizing the first positive electrode, the negative electrode, and the second positive electrode using an upper roll and a lower roll.

19. The manufacturing method of claim 14, wherein
the first operation includes
an 11^{th} operation of providing the first positive electrode by attaching it to an upper roll such that the first positive electrode is stacked on the first solid electrolyte layer provided on a first surface of the negative electrode on which the band-shaped negative electrode advances,
a 12^{th} operation of providing the second positive electrode by attaching it to a lower roll such that the second positive electrode is stacked on the second solid electrolyte layer spaced apart from the first positive electrode in the longitudinal direction of the negative electrode, and
a 13^{th} operation of pressurizing the first positive electrode, the negative electrode, and the second positive electrode using the upper roll and the lower roll.

20. The manufacturing method of claim 14, wherein
the first operation includes
an 11^{th} operation of providing the first positive electrode by attaching it to a first plate such that the first positive electrode is stacked on the first solid electrolyte layer provided on a first surface of the negative electrode on which the band-shaped negative electrode advances,
a 12^{th} operation of pressurizing and attaching the first positive electrode to the first surface of the negative electrode by pressure between the first plate and a first roll,
a 13^{th} operation of providing the second positive electrode by attaching it to a second plate such that the second positive electrode is stacked on the second solid electrolyte layer spaced apart from the first positive electrode in the longitudinal direction of the negative electrode, and
a 14^{th} operation of pressurizing and attaching the second positive electrode to a second surface of the negative electrode 10 by pressure between the second plate and a second roll.

21. The manufacturing method of claim 14, wherein
the first operation includes
an 11^{th} operation of providing the first positive electrode by attaching it to a first plate such that the first positive electrode is stacked on the first solid electrolyte layer provided on a first surface of the negative electrode on which the band-shaped negative electrode advances,
a 12^{th} operation of pressurizing and attaching the first positive electrode to the first surface of the negative electrode by pressure between the first plate and a first press,
a 13^{th} operation of providing the second positive electrode by attaching it to a second plate such that the second positive electrode is stacked on the second solid electrolyte layer spaced apart from the first positive electrode in the longitudinal direction of the negative electrode, and
a 14^{th} operation of pressurizing and attaching the second positive electrode to a second surface of the negative electrode 10 by pressure between the second plate and a second press.

22. The manufacturing method of claim 14, wherein
the first operation includes
an 11^{th} operation of providing the first positive electrode between a left roll and the first solid electrolyte layer such that the first positive electrode is stacked on the first solid electrolyte layer provided on a first surface of the negative electrode on which the band-shaped negative electrode advances upward,
a 12^{th} operation of providing the second positive electrode between a right roll and the second solid electrolyte layer such that the second positive electrode is stacked on the second solid electrolyte layer spaced apart from the first positive electrode in the longitudinal direction of the negative electrode, and
a 13^{th} operation of pressurizing the first positive electrode, the negative electrode, and the second positive electrode using the left roll and the right roll.

23. The manufacturing method of claim 14, wherein
the first operation includes
an 11^{th} operation of providing the first positive electrode between a left roll and the first solid electrolyte layer such that the first positive electrode is stacked on the first solid electrolyte layer provided on a first surface of the negative electrode on which the band-shaped negative electrode advances downward,
a 12th operation of providing the second positive electrode between a right roll and the second solid electrolyte layer such that the second positive electrode is stacked on the second solid electrolyte layer spaced apart from the first positive electrode in the longitudinal direction of the negative electrode, and
a 13^{th} operation of pressurizing the first positive electrode, the negative electrode, and the second positive electrode using the left roll and the right roll.
